(19) United States
(12) Patent Application Publication
(10) Pub. No.: US 2022/0291331 A1
(43) Pub. Date: Sep. 15, 2022

(54) MEASURING DEVICE FOR SENSING A PROCESS VARIABLE IN A CONTAINER

(71) Applicant: VEGA Grieshaber KG, Wolfach (DE)

(72) Inventors: Levin DIETERLE, Oberwolfach (DE); Roland WELLE, Hausach (DE); Joerg BOERSIG, Schapbach (DE); Steffen WAELDE, Niedereschach (DE); Christian WEINZIERLE, Wolfach (DE)

(73) Assignee: VEGA Grieshaber KG, Wolfach (DE)

(21) Appl. No.: 17/626,270

(22) PCT Filed: Jul. 30, 2019
(86) PCT No.: PCT/EP2019/070471

§ 371 Date: Jan. 11, 2022

(51) Int. Cl. G01S 7/02; G01F 23/80; G01F 23/284; G01F 23/296; G01S 13/88; G01S 15/88; H01Q 1/22

(52) U.S. Cl. CPC G01S 7/027; G01F 23/804; G01F 23/284; G01F 23/296; G01S 13/88; G01S 15/88; H01Q 1/225

(57) ABSTRACT

A measuring device, configured to detect a process variable in a container, is provided, the measuring device including: electronic circuitry with a housing and a sealing abutting the housing, the measuring device being further configured to be arranged in a container opening, and when the measuring device is arranged in the container opening: the sealing is configured to seal the container opening, and the electronic circuitry is arranged below a geometric plane of the sealing. A container including a container opening and the measuring device is also provided.

### FIELD OF THE INVENTION

The invention relates to a measuring device for detecting a process variable in a container, and to a container having a container opening and a measuring device arranged therein.

### BACKGROUND OF THE INVENTION

Sensors that record data or properties of process variables or substances inside a vessel are usually mounted on the vessel outside the vessel or they are mounted inside the vessel and the vessel is tightly sealed after mounting so that the filling medium cannot escape from the vessel. Therefore, they are installed, for example, from the outside by means of a screw thread and the electronics unit is located outside the vessel while the sensor technology (antenna) is inside the vessel. Furthermore, there are measuring instruments where, for example, only an antenna is located inside the vessel.

However, measuring devices or sensors that are located in a sealed container cannot be flexibly mounted or dismounted without further ado. Sensors that are located outside the container or partially inside the container have the disadvantage that the containers cannot be assembled in a space-saving manner, for example stacked on top of each other. Furthermore, in the case of mobile containers such as so-called intermediate bulk containers (IBCs), there is a risk that the sensor system may suffer damage or even be destroyed when the container is manoeuvred with a forklift truck.

### SUMMARY OF THE INVENTION

It is therefore the object of the invention to find a measuring device for a container and a container with a measuring device, which are configured in such a way that the containers can be set up in a space-saving manner and the measuring device can nevertheless be mounted flexibly.

The object is solved by the features of the independent patent claims. Advantageous embodiments are the subject of the dependent claims, the following description, and the figures.

According to a first aspect, there is provided a measuring device for detecting a process variable in a container, comprising an electronic unit having a housing and a sealing, or sealing arrangement, abutting the housing. The measuring device is configured to be positioned in a container opening. The sealing arrangement is arranged to seal the container opening and the electronics unit is arranged below a geometric plane of the sealing arrangement when the measuring device is positioned in the container opening, i.e. when the measuring device is mounted there.

Measuring device is understood here to mean an arrangement which has a unit for the physical detection of the process variable, e.g. a physical sensor or a generator-receiver arrangement for e.g. ultrasonic waves or radar, and an electronic unit which provides at least the electrical power supply and which, depending on the application, for example electronically processes the detected process variable and makes it available as digital data. The electronic elements that can be used for this purpose, such as voltage regulators, voltage converters, protection circuits, analog-to-digital converters, filters, amplifiers, microprocessors, memory modules, signal generators, vibration generators, emitters, piezo converters, etc., are known to the skilled person.

For example, the measuring device can determine substances or components of a medium, such as a liquid or a gas in a container, or detect a temperature, a pressure or a level. The measuring device comprises, as mentioned above, an electronic unit for operating the sensor and providing the measurement data, which is mounted in a housing. The housing accommodates the electronics unit, protects it from environmental influences and is used in particular for mounting on or in the container. For this purpose, according to one embodiment, the housing has, for example, an external thread, so that it can be screwed into a container opening with a corresponding thread up to, for example, a projecting bearing surface, for example a circumferential projection at the end of the housing remaining outside the container. The height of the protruding portion may, for example, be such that it does not exceed a defined edge height at the top of the container, so that stacking of the containers is possible. At the bearing surface towards the container, a sealing arrangement, for example a sealing ring, surrounds the threaded shank at the end of the thread. Preferably, the shank portion enclosed by the sealing arrangement may be threadless. When the measuring device is screwed in, the sealing ring is pressed against the edge of the container opening, so that a sealing of the container is ensured.

The sealing thus consists, for example, of a sealing ring which, in the mounted state of the measuring device, runs along the e.g. circular container opening and seals the container. In this case, the plane of the sealing arrangement is the circular plane of the sealing ring abutting the circular opening. The term “below” is to be seen here in the reference system of the measuring device, in which, when mounted, the direction “downwards” points into the container perpendicular to the container opening. Thus, if the sensor is mounted on the container lid, it means that the part “below” a geometric plane of the sealing arrangement is inside the container. If the sensor is mounted laterally, the plane of the lateral container opening is perpendicular to the container bottom, or container lid, and “below” this plane means the part of the measuring device that protrudes into the container. This part houses the electronic unit. This is thus located in the area of the housing which is surrounded by the thread and is inside the container when screwed in, “inside” being defined by the plane of the sealing arrangement, e.g. the sealing ring.

According to one embodiment, the housing may have an internal thread or an external thread. In the case of an external thread, the housing is cylindrical and encloses the electronic unit. In the case of an internal thread, the housing is flared so that it forms the container cover and is screwed onto the container body. The electronic unit may then be integrally connected, for example in a part of the housing, to the extended housing or the container lid and may project downwards towards the container base in the assembled, i.e. screwed-in, state. The sealing arrangement with the sealing plane defined above is then located along the internal thread.

The electronic unit may alternatively be screwed into a second housing as described above from above or from the outside into a container opening of the container cover forming an extended housing, which has an internal thread.

As a further alternative, the electronics unit may be screwed into the container cover from below in a separate housing. The separate housing can have a second sealing arrangement at the lower end of the external thread of the separate housing. For the definition “below a geometric plane of the sealing arrangement”, the sealing arrangement at the internal thread is decisive in this case.

According to one embodiment, the electronic unit comprises a sensor, an antenna and a communication unit. The sensor is arranged to detect a measurement signal, for example by transmitting a radar signal via the antenna and receiving the reflected signal again via the antenna, or for example by detecting a temperature or a pressure. Furthermore, it may comprise an evaluation unit which, for example, conditions analogue measurement signals and converts them into digital data, stores them temporarily and outputs them. The power supply is arranged to supply the sensor and possibly the antenna with power via a suitable voltage, and the communication unit is arranged to receive, for example, control signals by means of which, for example, a measurement is triggered, specific data can be retrieved in a specific format or synchronization can take place, and to receive the digital measurement data from the sensor, to embed and the data in a format corresponding to a transmission protocol, and finally to provide or transmit the measurement data generated from the measurement signal in accordance with the transmission protocol.

According to one embodiment, the communication unit may be a communication unit for wireless communication. In this case, the electronic unit is arranged to be supplied with electrical energy by a battery, so that no external wiring of the measuring device is necessary, and the container for the measuring device can be placed at any location. Alternatively, the communication unit may be a communication unit for wired communication. However, this requires an external interface for connecting wires, for example arranged on the side of the housing outside the container. The advantage of this variant is that power can be supplied via the external interface, thus eliminating the need for battery voltage monitoring and battery maintenance.

According to one embodiment, the housing may comprise a structure for receiving a tool for mounting from the outside of the container. Such a structure is, for example, a recess on the upper side of the gauge that corresponds to the shape of the tool, e.g. a barrel wrench or a bung wrench, so that the tool can engage in the recess and can support the screwing in or unscrewing of the gauge.

According to one embodiment, the side of the housing within the container facing the bottom of the container is shaped to have one or more inclinations relative to the horizontal for draining liquid or condensate. The liquid may be, for example, the fluid in the container or a condensate that has formed on the housing in the container. The inclination may be implemented, for example, by a conical formation at the lower part of the housing which is cylindrical according to one embodiment. The fluid may, for example, be drained along the inclination to the tip of the conical shape and drip there.

According to one embodiment, the housing, which is cylindrical at least between the sealing arrangement and the one or more inclinations, advantageously has a constant diameter in this region. For example, the diameter is two inches. Thus, for example, the thread, for example a two-inch thread, can be arranged in this region, and the entire housing can be screwed in and unscrewed again, for example from the outside, except for the possibly existing projecting projection.

According to one embodiment, the measuring device is flush with the container and/or the lid on the outside in one plane. This is possible if, for example, there is an indentation or depression of the edge of the container opening corresponding to the height of the protruding projection of the measuring device, i.e. the part of the housing above the plane of the sealing arrangement. Alternatively, the protruding protrusion of the housing may be absent and the sealing arrangement may be recessed protrudingly in a notch of the housing so that the sealing arrangement is pressed laterally against, for example, an upper unthreaded rim of the container opening.

According to one embodiment, the measuring device further comprises a venting and bleeding valve for pressure compensation of the pressure differences which occur, for example, due to evaporation of the medium, withdrawal of the medium, filling of the container or due to temperature changes. For this purpose, corresponding channels for the supply and discharge of air or gas are provided in the housing.

According to one embodiment, the sensor is a radar sensor, an ultrasonic sensor or a sensor for level detection. Depending on the embodiment, a sensor for level detection can also be screwed into the side of the container, i.e. the container opening is then located in the side wall of the container.

According to one embodiment, the housing is made of plastic (e.g., hard polyethylene, HDPE) and/or metal, such as aluminum, brass, or stainless steel.

According to a second aspect, there is provided a container having a container opening and a measuring device disposed therein as described above.

The container may be, for example, a drum or a canister made of plastic, tinplate, stainless steel or wood. A canister may, for example, have a screw opening that is lowered relative to the surface and has an external thread or an internal thread. A wooden barrel may, for example, have an opening into which an adapter with a corresponding internal thread can be inserted to receive the measuring device, or the housing may have a thread diameter tapering downwards, i.e. into the barrel.

The fact that the measuring device can be completely or almost completely screwed into the container due to its shape and does not protrude or only protrudes a little at the top makes it possible that several containers can be stacked on top of each other, for example. Rectangular containers with laterally mounted measuring device can be placed next to each other without or with only a small distance, depending on the exact shape of the container and the design of the housing or the container.

### SHORT DESCRIPTION OF THE FIGURES

In the following, embodiments of the invention will be described in detail with reference to the accompanying figures. Neither the description nor the figures are intended to be construed as limiting the invention. Hereby shows

FIG. 1 a measuring device for a container with an electronic unit outside the container,

FIG. 2 a measuring device for a container and a container according to a first embodiment with an electronic unit below the sealing arrangement,

FIG. 3 a measuring device for a container and a container according to a second embodiment with an aeration and venting valve,

FIG. 4 a measuring device for a container and a container according to a third embodiment with a point level sensor according to the capacitive measuring principle,

FIG. 5 a container lid and a measuring device according to a fourth embodiment,

FIG. 6 a measuring device for a container and a container according to a fifth embodiment, wherein the top of the measuring device and the top of the container are arranged flush.

FIG. 7 a measuring device for a container and a container according to a sixth embodiment, wherein the top of the measuring device and the top of the container are also flush.

The drawings are only schematic and not to scale. In principle, identical or similar parts are provided with the same reference signs.

### DETAILED DESCRIPTION OF THE FIGURES

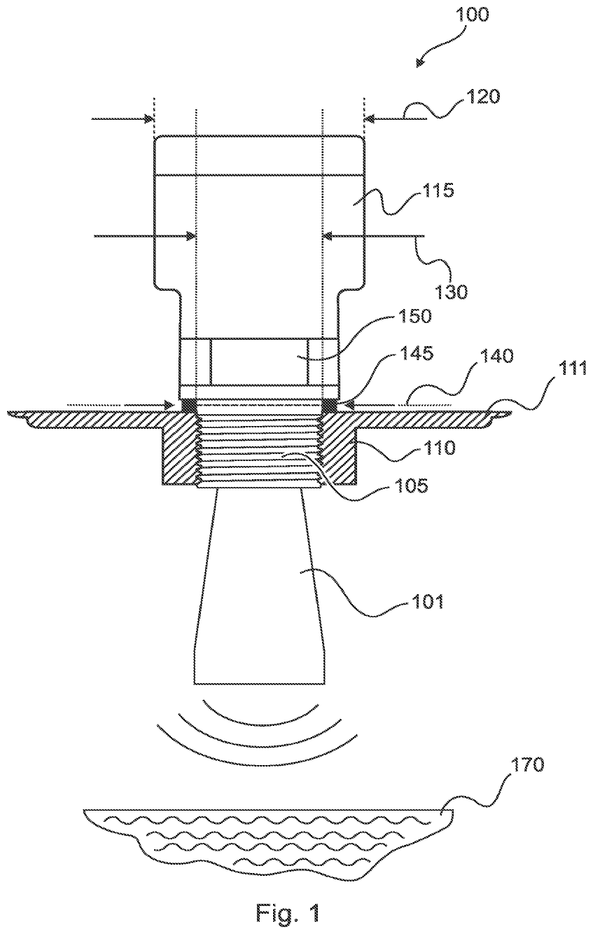

FIG. 1 shows an example of a level sensor 100 in which only the antenna 101 protrudes into the container, while the electronics housing 115 is located outside the container. The antenna 101 transmits signals, for example a radar signal, which is reflected by the liquid 170 in the container and is received back by the antenna 101 for level measurement. The electronics housing 115 has a thread 105 located below the electronics housing, which has a feedthrough in the thread whereby the antenna 101, which extends into the container, can be connected to the sensor 150. In this regard, the external thread 105 of the housing 115 engages the internal thread 110 of the container cover 111. The diameter 120 of the electronics housing 115 may be larger than the diameter 130 of the thread. In the example in FIG. 1, the housing 115 is wider than the opening for the thread 105 so that it is pressed onto the sealing rings 145 when it is screwed in and the arrangement is tight.

In FIG. 1, the electronics unit in the housing 115 is above the plane 140 formed by the sealing ring 145. Because the diameter 120 of the electronics housing 115 is larger than the diameter 130 of the thread 105, the electronics unit cannot protrude into the container. Thus, the electronics housing 115 protrudes upwardly from the container so that the container is not stackable.

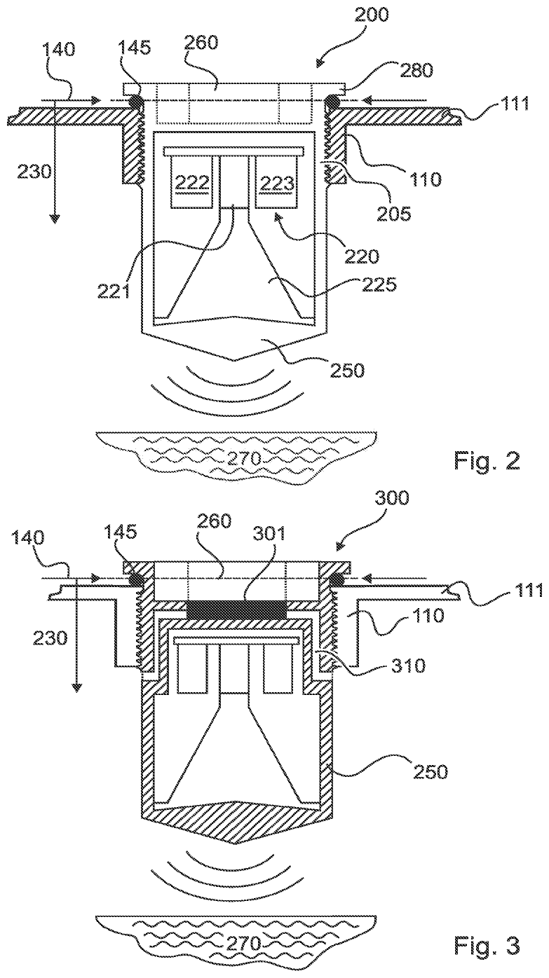

FIG. 2 shows a measuring device 200 according to a second embodiment and a container 111. The measuring device 200 includes an electronic unit 220 with a sensor 221, a communication unit 222 and a power supply unit 223 including an antenna 225. The housing 250 of the measuring device 200 further includes a thread 205 with which the measuring device 200 can be screwed into an opening of the container, which also includes a corresponding thread 110. The gauge 200 has a diameter corresponding to the thread diameter, such that the gauge 200 can be screwed into the container 290 almost completely, except for an overhanging protrusion 280. The overhanging protrusion 280 limits screwing in so that the gauge 200 cannot be screwed through the threads 110, and also allows pressure to be applied to the sealing ring 145 so that the housing 250 of the gauge 200 tightly seals the container 290. Antenna 225 has a maximum diameter which is smaller than that of thread 110 or thread 205.

The electronic unit is thus located substantially inside the container in the half-space 230 facing the medium, the upper boundary of which is defined by the sealing plane 140 in which the sealing ring 145 is located. In this regard, the housing shape on the outside of the container has a geometry 260 which facilitates screwing in with an appropriate tool, for example a bunghole wrench. Furthermore, the tip of the housing has a geometry 250, for example conical, which facilitates the dripping of condensate and medium 270.

FIG. 3 shows a measuring device 300 in a further embodiment which, in addition to the features shown in FIG. 2, has an aeration and deaeration valve 301 which enables pressure equalisation between the inside of the container and the environment via the gas channels 310 in order to facilitate filling or emptying processes.

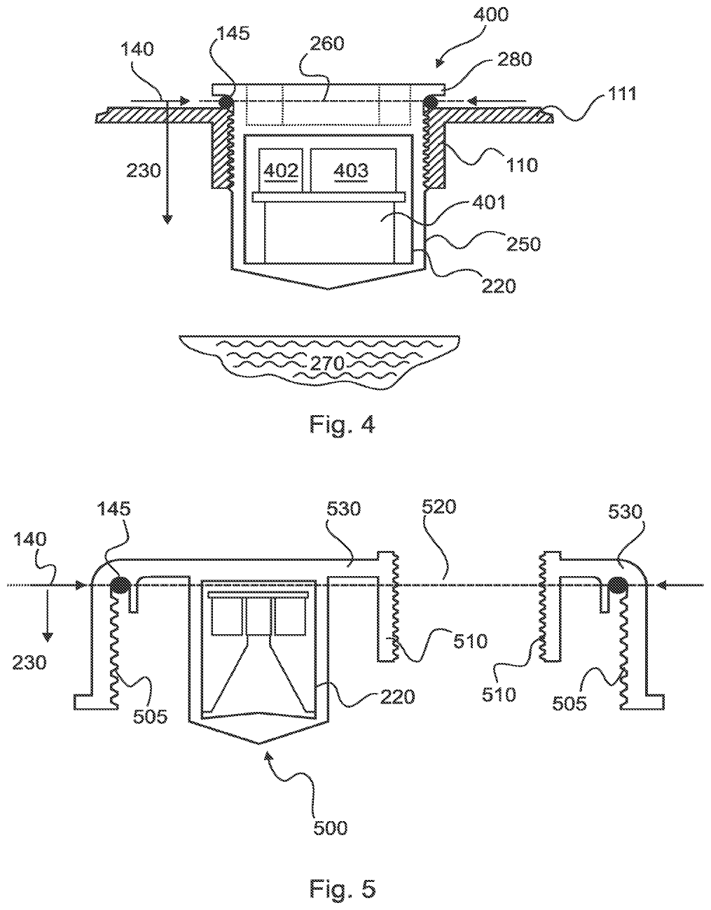

FIG. 4 shows a measuring device 400 in a further embodiment, wherein the sensor 401 is a point level sensor 401 which functions, for example, according to the capacitive measuring principle. That is, compared to the arrangement in FIG. 2, the antenna 225 is missing, and the communication unit 402 and the power supply unit 403 are located above the point level sensor 401. Also in this embodiment example, the complete electronic unit comprising the communication unit 402, the power supply unit 403 and the point level sensor 401 is arranged completely below the sealing plane 140. Only the upper protrusion 280 protrudes from the container. Depending on the measuring principle used, the geometry of the housing part facing the medium can be designed according to the physical requirement of the measuring principle.

FIG. 5 shows a container lid 530 and a measuring device 500 integrally formed with the container lid 530, in another embodiment. The container lid 530 has an internal thread 505 so that it can be screwed onto the container. The container lid may, for example, be of size DN 150 with NW 150-internal thread S165×7 or of size DN 225 with NW 225-internal thread S245×6, and may have one or more optional threaded connections 510 each with an optional container opening 520 for screwing in, for example, a measuring device or for inserting a suction nozzle. According to the embodiments, the container lid 530 may also comprise either only the integrally integrated measuring device 500, that is without further container opening 520 and thread 510. Furthermore, the container lid 530 may comprise only the opening 520 with thread 510 without measuring device 500, into which a measuring device explained above may be screwed. The sealing plane of the measuring device is also above the electronic unit 220 in these embodiments. Furthermore, the lid may also comprise a vent valve.

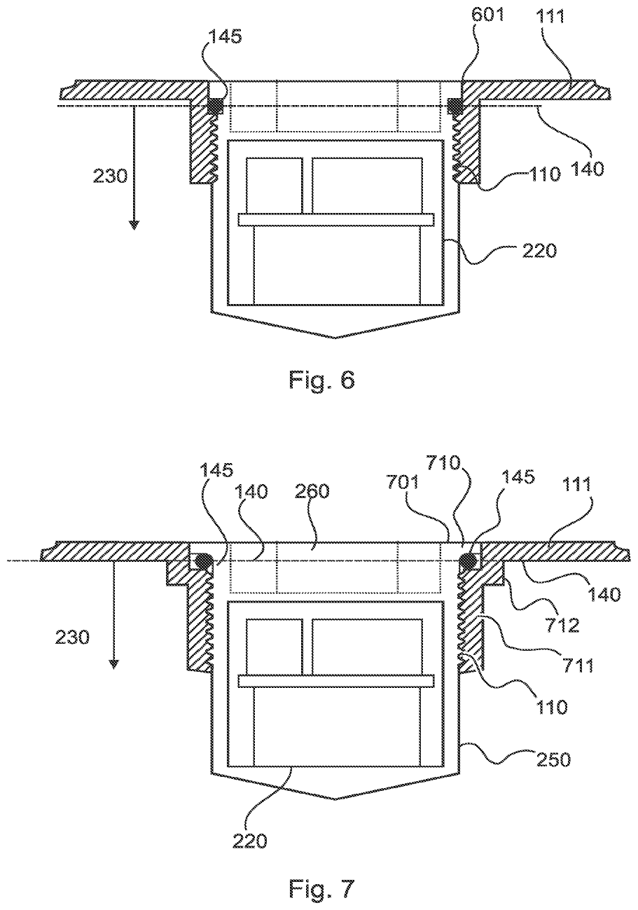

FIG. 6 shows a measuring device for a container and a container according to a fifth embodiment in which the upper side of the measuring device 601 and the upper side of the container 111 are flush, i.e. planar, when mounted. The sealing ring 145 is pressed laterally against the container opening during or after screwing-in. Preferably, the wall of the container opening does not have a thread at the upper part, so that the sealing ring can slide down this part of the wall when it is screwed in.

FIG. 7 shows a gauge for a container and a container with a thread 110 according to a sixth embodiment in which the gauge top 701 and the container top 111 are also arranged flush. In this example, the wall of the container opening is divided into a first portion 711 having the thread 110 and a second portion 712 without threads, which is arranged outwardly offset from the first portion. The housing 250 has a circumferential projection 710 on its upper part, which presses the sealing ring 145 onto the upper surface of the first part 711 when the housing 250 is screwed into the container opening, thus achieving the sealing effect.

Also in the embodiment examples according to FIG. 6 and FIG. 7, the electronic unit 220 is in each case located below the plane 140 formed by the sealing ring, so that the containers with the mounted measuring devices have an outer shape which allows the containers to be set up or stacked even in space-critical locations, and the measuring devices can nevertheless be removed or used flexibly.

1.-13. (canceled)

14. A measuring device, configured to detect a process variable in a container, the measuring device comprising:
electronic circuitry with a housing and a sealing abutting the housing,
wherein the measuring device is further configured to be arranged in a container opening, and
wherein, when the measuring device is arranged in the container opening:
the sealing is configured to seal the container opening, and
the electronic circuitry is arranged below a geometric plane of the sealing.

15. The measuring device according to claim 14, wherein the housing comprises a thread configured to screw the measuring device into the container opening.

16. The measuring device according to claim 14, wherein the housing comprises an internal thread or an external thread.

17. The measuring device according to claim 14, wherein the electronic circuitry comprises:
a sensor configured to detect a measurement signal,
an energy supply,
an antenna connected to the sensor and configured to transmit and to receive the measurement signal, and
communication circuitry configured to receive control signals and to provide and transmit measurement data from the measurement signal in accordance with a transmission protocol.

18. The measuring device according to claim 17,
wherein the communication circuitry is circuitry configured for wireless communication, and the electronic circuitry is configured to be supplied with electric power by a battery, or
wherein the communication circuitry is circuitry configured for wired communication.

19. The measuring device according to claim 14, wherein the housing comprises a structure configured to receive a tool for mounting from an outside of the container.

20. The measuring device according to claim 14, wherein a side of the housing facing a bottom of the container is shaped within the container such that the side has one or more inclinations with respect to a horizontal that are configured for draining liquid or condensate.

21. The measuring device according to claim 14, wherein the measuring device is flush with the container and/or a lid in one plane on an outside.

22. The measuring device according to claim 20, wherein the housing has a constant diameter cylindrical shape at least between the sealing and the one or more inclinations.

23. The measuring device according to claim 14, further comprising an aeration and deaeration valve.

24. The measuring device according to claim 17, wherein the sensor is a radar sensor, an ultrasonic sensor, or a level detection sensor.

25. The measuring device according to claim 14, wherein the housing is made of plastic and/or metal.

26. A container, comprising:
a container opening; and
a measuring device according to claim 14,
wherein the measuring device is disposed in the container opening.
